(19) United States
(12) Patent Application Publication
(10) Pub. No.: US 2025/0227715 A1
(43) Pub. Date: Jul. 10, 2025

(54) METHOD, USER EQUIPMENT AND NETWORK NODE

(71) Applicant: NEC CORPORATION, Tokyo (JP)

(72) Inventors: Tingyu XIN, Tokyo (JP); Pravjyot DECOGUN, Tokyo (JP)

(73) Assignee: NEC CORPORATION, Mirato-ku, Tokyo (JP)

(21) Appl. No.: 18/853,739

(22) PCT Filed: Apr. 21, 2023
(86) PCT No.: PCT/JP2023/016015

§ 371 Date: Oct. 3, 2024

(30) Foreign Application Priority Data
Apr. 28, 2022 (GB) 2206252.5

(51) Int. Cl. H04W 72/231; H04L 1/1812; H04W 76/20; H04W 84/06

(52) U.S. Cl. CPC H04W 72/231; H04L 1/1812; H04W 76/20; H04W 84/06

(57) ABSTRACT

The present disclosure relates to a method for a user equipment (UE) (3), the method comprising: receiving first information that includes an indication for a Hybrid Automatic Repeat Request (HARQ) process; and determining whether a feedback for the HARQ process is enabled or not based on the first information.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to improvements relating Hybrid Automatic Repeat Request (HARQ) feedback.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. End-user communication devices are commonly referred to as User Equipment (UE) which may be operated by a human or comprise automated devices. Such communication devices might be, for example, mobile communication devices such as mobile telephones, smartphones, smart watches, personal digital assistants, laptop/tablet computers, web browsers, e-book readers, connected vehicles, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC, IoT/Industrial IoT (IIoT) communications, vehicular communications and autonomous cars, high resolution video streaming, smart city services, and/or the like. 3GPP intends to support 5G by way of the so-called 3GPP Next Generation (NextGen) radio access network (RAN)/radio access technology (RAT) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

3GPP is also working on specifying an integrated satellite and terrestrial network infrastructure in the context of 4G and 5G. The term Non-Terrestrial Networks (NTN) refers to networks, or segments of networks, that are using an airborne or spaceborne vehicle for transmission. Satellites refer to spaceborne vehicles in Geostationary Earth Orbit (GEO) or in Non-Geostationary Earth Orbit (NGEO) such as Low Earth Orbits (LEO), Medium Earth Orbits (MEO), and Highly Elliptical Orbits (HEO). Airborne vehicles refer to High Altitude Platforms (HAPs) encompassing Unmanned Aircraft Systems (UAS)-including tethered UAS, Lighter than Air UAS and Heavier than Air UAS-all operating quasi-stationary at an altitude typically between 8 and 50 km.

3GPP Technical Report (TR) 38.811 V15.4.0 is a study on New Radio to support such Non-Terrestrial Networks. The study includes, amongst others, NTN deployment scenarios and related system parameters (such as architecture, altitude, orbit etc.) and a description of adaptation of 3GPP channel models for Non-Terrestrial Networks (propagation conditions, mobility, etc.). 3GPP TR 38.821 V16.1.0 provides further details about NTN.

Non-Terrestrial Networks are expected to:
help foster the 5G service roll out in un-served or underserved areas to upgrade the performance of terrestrial networks;
reinforce service reliability by providing service continuity for user equipment or for moving platforms (e.g. passenger vehicles-aircraft, ships, high speed trains, buses);
increase service availability everywhere; especially for critical communications, future railway/maritime/aeronautical communications; and
enable 5G network scalability through the provision of efficient multicast/broadcast resources for data delivery towards the network edges or even directly to the user equipment.

NTN access typically features the following elements (amongst others):
NTN Terminal: It may refer to a 3GPP UE or a terminal specific to the satellite system in case the satellite doesn't serve directly 3GPP UEs.
A service link which refers to the radio link between the user equipment and the space/airborne platform (which may be in addition to a radio link with a terrestrial based RAN).
A space or an airborne platform (e.g. a satellite).
Gateways (‘NTN Gateways’) that connect the satellite or aerial access network to the core network. It will be appreciated that gateways will mostly likely be co-located with a base station. Alternatively, the gateway and base station may be provided separately. In one alternative, some or all of the functions of the base station may instead be provided at the satellite (or another non-terrestrial node).
Feeder links which refer to the radio links between the gateways and the space/airborne platform.

Satellite or aerial vehicles may generate several beams over a given area to provide respective NTN cells. The beams have a typically elliptic footprint on the surface of the Earth.

3GPP intends to support three types of NTN beams or cells:
Earth-fixed cells characterized by beam(s) covering the same geographical areas all the time (e.g. GEO satellites and HAPS);
quasi-Earth-fixed cells characterized by beam(s) covering one geographic area for a finite period and a different geographic area during another period (e.g. NGEO satellites generating steerable beams); and
Earth-moving cells characterized by beam(s) covering one geographic area at one instant and a different geographic area at another instant (e.g. NGEO satellites generating fixed or non-steerable beams).

With satellite or aerial vehicle keeping position fixed in terms of elevation/azimuth with respect to a given earth point e.g. GEO and UAS, the beam footprint is earth fixed.

With satellite circulating around the earth (e.g. LEO) or on an elliptical orbit around the earth (e.g. HEO) the beam footprint may be moving over the Earth with the satellite or aerial vehicle motion on its orbit. Alternatively, the beam footprint may be Earth-fixed (or quasi-Earth-fixed) temporarily, in which case an appropriate beam pointing mechanism (mechanical or electronic steering) may be used to compensate for the satellite or aerial vehicle motion.

### SUMMARY OF INVENTION

### Technical Problem

LEO satellites may have steerable beams in which case the beams are temporarily directed to substantially fixed footprints on the Earth. In other words, the beam footprints (which represent NTN cell) are stationary on the ground for a certain amount of time before they change their focus area over to another NTN cell (due to the satellite's movement on its orbit). From cell coverage/UE point of view, this results in cell changes happening regularly at discrete intervals because different Physical Cell Identities (PCIs) and/or Synchronization Signal/Physical Broadcast Channel (PBCH) blocks (SSBs) have to be assigned after each service link change, even when these beams serve the same land area (have the same footprint). LEO satellites without steerable beams cause the beams (cells) moving on the ground constantly in a sweeping motion as the satellite moves along its orbit and as in the case of steerable beams, service link change and consequently cell changes happen regularly at discrete intervals. Similarly to service link changes, feeder link changes also happen at regular intervals due to the satellite's movement on its orbit. Both service and feeder link changes may be performed between different base stations/gateways (which may be referred to as an ‘inter-gNB radio link switch’) or within the same base station/gateway (‘intra-gNB radio link switch′).

In a wireless communication link some of the transmitted packets may be lost, or may be subject to errors introduced by noise or interference. The Hybrid Automatic Repeat Request (HARQ) procedure can be used to mitigate against such packet losses and errors by using re-transmission (or selective re-transmission) of data packets. For example, a UE may receive a transmission from a base station that includes errors or missing packets. The UE may attempt to correct errors in the received transmission where possible, and may provide feedback to the base station regarding the transmission that has been received, for example including an acknowledgement (ACK) or negative acknowledgement (NACK). Based on the feedback, the base station may re-transmit some or all of the original transmission. The HARQ procedure may include a number of simultaneous HARQ processes, each used for a respective part of the transmission. Therefore, when the base station is awaiting feedback from the UE corresponding to a particular HARQ process (and therefore to a particular part of the transmission), the base station can continue transmission of data for the other HARQ processes.

In non-terrestrial networks, the round-trip time between the user equipment and the base station is large compared to terrestrial networks, due to propagation delays in the service link and/or the feeder link. Therefore, since the HARQ procedure includes the transmission of feedback and the re-transmission of data, implementing the HARQ procedure in a non-terrestrial network may significantly reduce the overall throughput of transmissions due to the delays caused by the increased round-trip time between the UE and the base station, and may result in so-called ‘HARQ stalling’. However, disabling the HARQ procedure degrades the reliability of the transmissions due to the lack of feedback. Therefore, it is challenging to ensure that transmissions in a non-terrestrial network can be performed reliably, whilst also ensuring that excessive delays are not introduced. This problem is particularly challenging when the transmissions are between an IoT device and a bases station, since feedback procedures should also be compatible with the low-complexity, low-cost, low-power consumption, and low-throughput requirements of IoT services (including extended coverage, delay-tolerant and infrequent data transmissions, and support of massive communications).

The present disclosure seeks to provide methods and associated apparatus that address or at least alleviate (at least some of) the above-described issues.

### Solution to Problem

In a first aspect the disclosure provides a method for a user equipment (UE), the method comprising: receiving first information that includes an indication for a Hybrid Automatic Repeat Request (HARQ) process; and determining whether a feedback for the HARQ process is enabled or not based on the first information.

The first information may include feedback configuration information for the HARQ process supported by the UE, wherein the feedback configuration information indicates that HARQ feedback is disabled for the HARQ process, and the determining may include enabling feedback for the HARQ process in a case where a downlink transmission is a specific type of downlink transmission.

The first information may include downlink control information for the HARQ process; and the determining may include determining whether the downlink control information includes an indication of whether the feedback for the HARQ process is to be enabled or disabled for a downlink transmission.

The method may further comprise determining, in a case where the downlink transmission is for transmission in a cell of a non-terrestrial network portion, that the downlink control information includes the indication.

The determination of whether the downlink control information includes the indication may be based on system information broadcast in a cell.

The method may further comprise receiving control signalling that includes an indication of whether the downlink control information is adapted to include the indication; and determining whether the downlink control information includes the indication based on the control signalling.

The method may further comprise receiving, from a network node, a cell-specific feedback indication that indicates whether Hybrid Automatic Repeat Request (HARQ) feedback is to be enabled or disabled for downlink transmissions in a cell; wherein the receiving the first information includes receiving from the network, a UE-specific feedback indication that indicates whether the feedback for HARQ process is to be enabled for a downlink transmission, and the determining may include determining whether the feedback for the HARQ process is to be enabled based on the UE-specific feedback indication irrespective of the cell-specific feedback indication.

The receiving may include receiving, from a network node, configuration information for the feedback for the HARQ process; and the method may include using the configuration information to configure the feedback for the HARQ process for a procedure in which the UE performs data transmission to the network node in a radio resource control (RRC) idle state.

The data transmission to the network node may use preconfigured uplink resources (PUR).

The HARQ feedback configuration information may be received from the network node when the UE is in an RRC connected state.

Thee HARQ feedback configuration information may be received from the network node when the UE is in an RRC idle state.

The method may further comprise: receiving the HARQ feedback configuration information from the network node in a preconfigured uplink resource (PUR) configuration message; or receiving a PUR configuration message that indicates that downlink control information transmitted by the network node includes the HARQ feedback configuration information.

In a second aspect the disclosure provides a method for a network node, the method comprising: transmitting, to a user equipment (UE), first information that includes an indication for at least one Hybrid Automatic Repeat Request (HARQ) process, wherein the first information causes the UE to determine whether a feedback for the at least one HARQ process is enabled or not based on the first information.

The first information may include control information for the UE, wherein the control information indicates that the feedback for the at least one HARQ process is disabled, and the method may further comprise: transmitting downlink transmission to the UE; and receiving the feedback for the at least one HARQ process in a case where the downlink transmission is a specific type of downlink transmission.

The method may further comprise: in a case where the downlink transmission is the specific type of downlink transmission, transmitting, to the UE, an indication that the feedback for the at least one HARQ process is to be enabled.

The specific type of downlink transmission may be a Physical Downlink Shared Channel (PDSCH) transmission that carries a radio resource control (RRC) message, or a medium access control control element (MAC CE).

The first information may include downlink control information for the UE, wherein the downlink control information includes an indication of whether the feedback for the at least one HARQ process is to be enabled or disabled for a downlink transmission.

The downlink transmission may be scheduled by the downlink control information.

The indication may be included in a bit of the downlink control information.

The method may further comprise: determining to include, in the downlink control information, a bit for indicating whether the feedback for the at least one HARQ process is to be enabled, when the downlink control information is transmitted in a cell provided using a non-terrestrial network portion.

The downlink control information may indicate whether feedback for all HARQ processes of the UE is to be enabled for at least one downlink transmission.

The downlink control information may indicate whether feedback for at least one specific HARQ process of the UE is to be enabled for a downlink transmission.

The method may further comprise: transmitting control signalling for indicating whether the downlink control information includes the indication.

The control signalling may include radio resource control (RRC) signalling.

The control signalling may be UE-specific control signalling.

The control signalling may include a plurality of bits for indicating whether the downlink control information includes an indication of whether the feedback for the at least one HARQ process is to be enabled, each bit respectively indicating whether the downlink control information includes an indication of whether the feedback for one of the at least one HARQ process is to be enabled.

The method may further comprise: transmitting system information for the UE that indicates whether the downlink control information includes the indication.

The downlink control information may further comprise an indication of configuration information for the at least one HARQ process.

The downlink control information may indicate, using information related to a modulation coding scheme (MCS) included in the downlink control information, whether the feedback for the at least one HARQ process is to be enabled for the transmission of a particular transport block, data packet or control element.

The first information may include a cell-specific or UE-specific feedback indication that indicates whether the feedback for the at least one HARQ process is to be enabled for a downlink transmission.

The feedback indication may be included in system information (SI) that is transmitted in a cell.

The feedback indication may include information indicating whether HARQ feedback is to be enabled or disabled for all or some HARQ processes in the cell of the non-terrestrial network portion.

The feedback indication may include a bitmap having a plurality of bits, each bit of the bitmap indicating whether HARQ feedback is to be enabled for a respective HARQ processes in the cell of the non-terrestrial network portion.

In a third aspect the disclosure provides a method performed by a network node in a network comprising a non-terrestrial network portion, the method comprising: selecting a Hybrid Automatic Repeat Request (HARQ) process that is configured with feedback enabled, of a plurality of HARQ processes supported by a user equipment (UE), for providing feedback for the HARQ process relating to a downlink transmission to be transmitted to the UE using the non-terrestrial network portion.

In a fourth aspect the disclosure provides a user equipment comprising: means for receiving first information that includes an indication for a Hybrid Automatic Repeat Request (HARQ) process; and means for determining whether a feedback for the HARQ process is enabled or not based on the first information.

In a fifth aspect the disclosure provides a network node comprising: means for transmitting, to a user equipment (UE), first information that includes an indication for at least one Hybrid Automatic Repeat Request (HARQ) process, wherein the first information causes the UE to determine whether a feedback for the at least one HARQ process is enabled or not based on the first information.

In a sixth aspect the disclosure provides a network node in a network comprising a non-terrestrial network portion, the network node comprising: means for selecting a Hybrid Automatic Repeat Request (HARQ) process that is configured with feedback enabled, of a plurality of HARQ processes supported by a user equipment (UE), for providing feedback for the HARQ process relating to a downlink transmission to be transmitted to the UE using the non-terrestrial network portion.

Also disclosed is a method performed by a network node, the method comprising: transmitting control information for a user equipment (UE) for a Hybrid

Automatic Repeat Request (HARQ) process, wherein the control information indicates that feedback is disabled for the HARQ process; transmitting downlink transmission to the UE; and receiving the HARQ feedback in a case where the downlink transmission is the specific type of downlink transmission.

Also disclosed is a method performed by a network node, the method comprising: transmitting downlink control information for a user equipment (UE) for a Hybrid Automatic Repeat Request (HARQ) process, wherein the downlink control information includes an indication of whether HARQ feedback is to be enabled or disabled for a downlink transmission.

Also disclosed is a method performed by a network node, the method comprising: transmitting a cell-specific or user equipment (UE)-specific feedback indication that indicates whether Hybrid Automatic Repeat Request (HARQ) feedback is to be enabled for downlink transmissions.

Also disclosed is a method performed by a user equipment (UE), the method comprising: obtaining feedback configuration information for a Hybrid Automatic Repeat Request (HARQ) process supported by the UE that indicates that HARQ feedback is disabled for the HARQ process; receiving a downlink transmission; enabling feedback for the HARQ process in a case where the downlink transmission is a first type of downlink transmission; and not enabling feedback for the HARQ process in a case where the downlink transmission is a second type of downlink transmission.

Also disclosed is a method performed by a user equipment (UE), the method comprising: receiving, from a network node in a network comprising a non-terrestrial network portion, downlink control information for a Hybrid Automatic Repeat Request (HARQ) process; and determining whether the downlink control information includes an indication whether Hybrid Automatic Repeat Request (HARQ) feedback is to be enabled for a downlink transmission.

Also disclosed is a method performed by a user equipment (UE), the method comprising: receiving, from a network node, a cell-specific feedback indication that indicates whether Hybrid Automatic Repeat Request (HARQ) feedback is to be enabled for downlink transmissions in a cell of the non-terrestrial network portion; receiving from the network, a UE-specific feedback indication that indicates whether HARQ feedback is to be enabled for a downlink transmission received by the UE; and determining whether HARQ feedback is to be enabled based on the UE-specific feedback indication irrespective of the cell-specific feedback indication.

Also disclosed is a method performed by a user equipment (UE), the method comprising: receiving, from a network node, Hybrid Automatic Repeat Request (HARQ) feedback configuration information; storing the HARQ feedback configuration information; and using the HARQ feedback configuration information to configure HARQ feedback for a procedure in which the UE transmits a message to the network node in a radio resource control (RRC) idle state.

Also disclosed is a user equipment (UE) comprising: means for receiving first information that includes an indication for a Hybrid Automatic Repeat Request (HARQ) process; and means for determining whether a feedback for the HARQ process is enabled or not based on the first information.

Also disclosed is a network node comprising: means for transmitting control information for a user equipment (UE) for a Hybrid Automatic Repeat Request (HARQ) process, wherein the control information indicates that feedback is disabled for the HARQ process; means for transmitting downlink transmission to the UE; and means for receiving the HARQ feedback in a case where the downlink transmission is the specific type of downlink transmission.

Also disclosed is a network node in a network comprising a non-terrestrial network portion, the network node comprising: means for selecting a Hybrid Automatic Repeat Request (HARQ) process that is configured with feedback enabled, of a plurality of HARQ processes supported by a UE, for providing feedback relating to a downlink transmission to be transmitted to the UE using the non-terrestrial network portion.

Also disclosed is a network node comprising: means for transmitting downlink control information for a user equipment (UE) for a Hybrid Automatic Repeat Request (HARQ) process, wherein the downlink control information includes an indication of whether HARQ feedback is to be enabled or disabled for a downlink transmission.

Also disclosed is a network node comprising: means for transmitting a cell-specific or user equipment (UE)-specific feedback indication that indicates whether Hybrid Automatic Repeat Request (HARQ) feedback is to be enabled for downlink transmissions.

Aspects of the disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Embodiments of the disclosure will now be described, by way of example, with reference to the accompanying drawings in which:

FIG. 1 illustrates schematically a mobile (cellular or wireless) telecommunication system to which embodiments of the disclosure may be applied;

FIG. 2 is a schematic block diagram of a mobile device;

FIG. 3 is a schematic block diagram of an access network node (e.g. base station);

FIG. 4 shows a procedure in which HARQ feedback is transmitted by a user equipment (UE);

FIG. 5 shows a procedure in which downlink control information is transmitted to a UE;

FIG. 6 shows a procedure in which control signalling is transmitted to a UE;

FIG. 7 shows a procedure in which downlink control information is transmitted to a plurality of UEs;

FIG. 8 shows a further procedure in which downlink control information is transmitted to a plurality of UEs;

FIG. 9 shows a preconfigured uplink resources (PUR) configuration request and PUR configuration procedure;

FIG. 10 shows a procedure including a transmission using PUR;

FIG. 11 shows a procedure including the transmission of HARQ feedback after a UE has received an RRC connection release message;

FIG. 12 shows a further procedure including the transmission of HARQ feedback after a UE has received an RRC connection release message;

FIG. 13 shows a further procedure including the transmission of HARQ feedback after a UE has received an RRC connection release message; and

FIG. 14 illustrates schematically some exemplary architecture options for the provision of NTN features.

### DESCRIPTION OF EMBODIMENTS

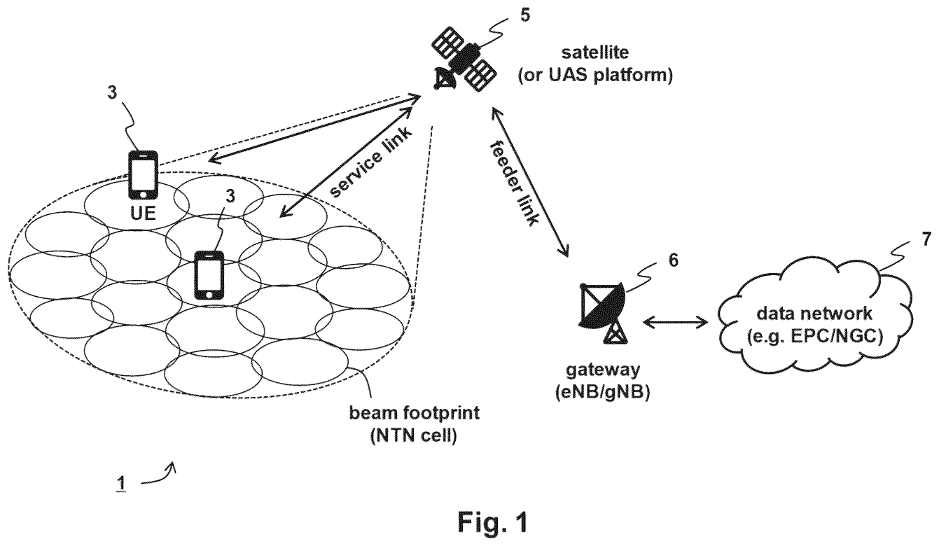

FIG. 1 illustrates schematically a mobile (cellular or wireless) telecommunication system 1 to which embodiments of the disclosure may be applied.

In this system 1, users of mobile devices 3 (UEs) can communicate with each other and other users via access network nodes respective satellites 5 and/or base stations 6 and a data network 7 using an appropriate 3GPP radio access technology (RAT), for example, an Evolved Universal Terrestrial Radio Access

(E-UTRA) and/or 5G RAT. As those skilled in the art will appreciate, whilst two mobile devices 3, one satellite 5, and one base station 6 are shown in FIG. 1 for illustration purposes, the system, when implemented, will typically include other satellites/UAS platforms, base stations/RAN nodes, and mobile devices (UEs). Some or all of the UEs may be Internet of Things (IoT) devices and similar Machine Type Communications (MTC) devices.

It will be appreciated that a number of base stations 6 form a (radio) access network or (R) AN, and a number of NTN nodes 5 (satellites and/or UAS platforms) form a Non-Terrestrial Network (NTN). Each NTN node 5 is connected to an appropriate gateway (in this case co-located with a base station 6) using a so-called feeder link and connected to respective UEs 3 via corresponding service links. Thus, when served by an NTN node 5, a mobile device 3 communicates data to and from a base station 6 via the NTN node 5, using an appropriate service link (between the mobile device 3 and the NTN node 5) and a feeder link (between the NTN node 5 and the gateway/base station 6). In other words, the NTN forms part of the (R) AN, although it may also provide satellite communication services independently of E-UTRA (or ‘4G’) and/or New Radio (or ‘5G’) communication services.

Although not shown in FIG. 1, neighbouring base stations 6 are connected to each other via an appropriate base station to base station interface (such as the so-called ‘X2’ interface, ‘Xn’ interface and/or the like). The base station 6 is also connected to the data network nodes via an appropriate interface (such as the so-called ‘S1’, ‘NG-C’, ‘NG-U’ interface, and/or the like).

The data (or core) network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the data network 7 of a ‘Next Generation’/5G system will include user plane entities and control plane entities, such as one or more control plane functions (CPFs) and one or more user plane functions (UPFs). The so-called Access and Mobility Management Function (AMF) in 5G, or the Mobility Management Entity (MME) in 4G, is responsible for handling connection and mobility management tasks for the mobile devices 3. The data network 7 is also coupled to other data networks such as the Internet or similar Internet Protocol (IP) based networks (not shown in FIG. 1).

Each NTN node 5 controls a number of directional beams via which associated NTN cells may be provided. Specifically, each beam has an associated footprint on the surface of the Earth which corresponds to an NTN cell. Each NTN cell (beam) has an associated Physical Cell Identity (PCI) and/or beam identity. The beam footprints may be moving as the NTN node 5 is travelling along its orbit. Alternatively, the beam footprint may be earth fixed, in which case an appropriate beam pointing mechanism (mechanical or electronic steering) may be used to compensate for the movement of the NTN node 5.

When the UE 3 initially establishes an RRC connection with a base station 6 via a cell it registers with an appropriate AMF 9 (or MME). The UE 3 is in the so-called RRC connected state and an associated UE context is maintained by the network. When the UE 3 is served via the NTN node 5, it receives and transmits data via one of the beams (NTN cells) of the NTN node 5. When the UE 3 is in the so-called RRC idle or in the RRC inactive state, it still needs to select an appropriate cell for camping so that the network is aware of the approximate location of the UE 3 (although not necessarily on a cell level).

Whilst the system illustrated in FIG. 1 includes a terrestrial gNB/TRP 6b, some or all of the functions of the gNB 6b may be provided at the serving satellite. For example, all of the functions of the gNB 6b may be provided at the satellite 5, and the gateway 6a may be arranged directly between the satellite 5 and the data network 7.

The satellite 5 may be configured to implement a transparent or a regenerative payload. For a transparent payload, the satellite 5 performs radio frequency filtering, frequency conversion and amplification, and signals received at the satellite 5 are simply repeated for transmission to the terrestrial gateway 6a. In other words, the waveform signal repeated by the satellite 5 is substantially unchanged. An exemplary control plane protocol stack for a transparent payload (for a transparent satellite) is described, for example, in TS 38.821.

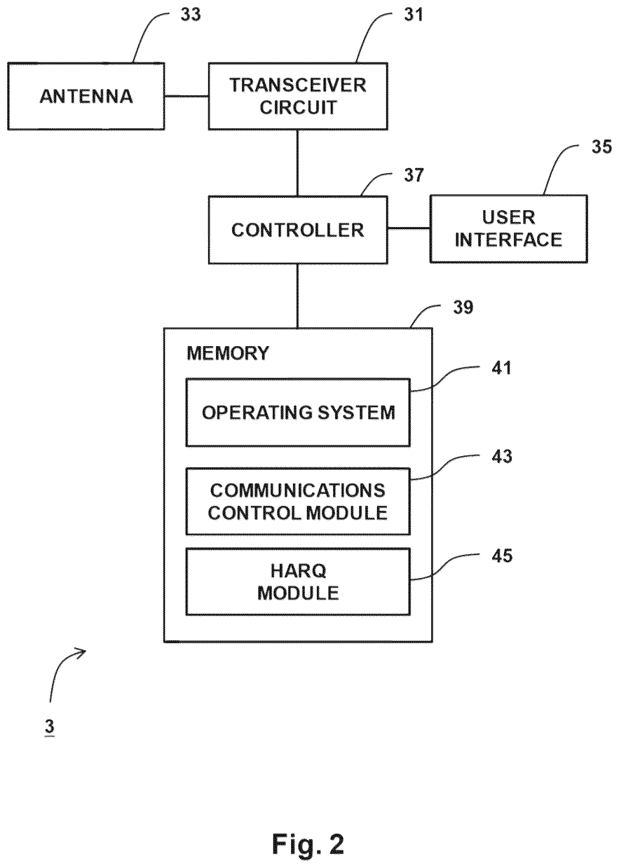

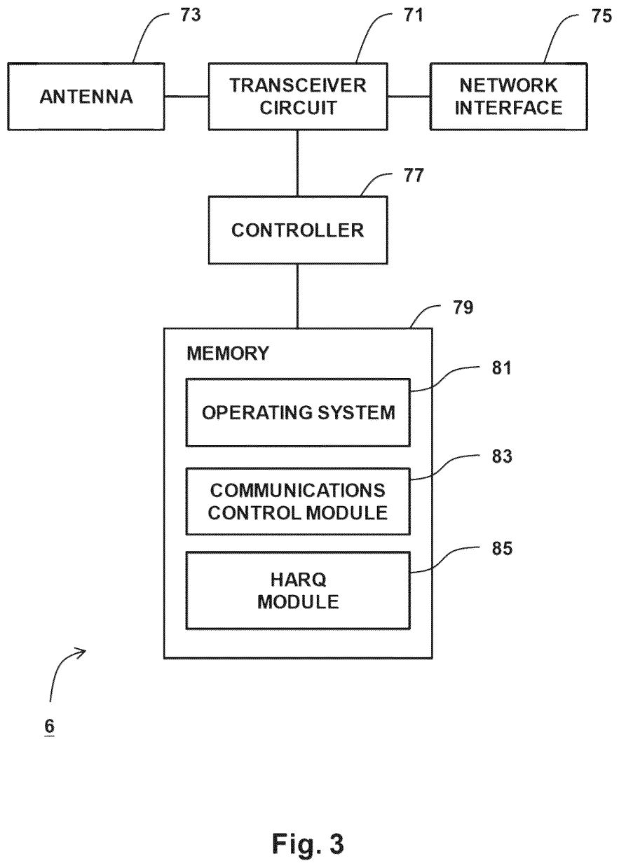

For a regenerative payload, the satellite 5 may be configured to perform radio frequency filtering, frequency conversion and amplification, demodulation/decoding, switching and/or routing, and coding/modulation. In other words, some or all of the functions of the gNB 6b are provided at the satellite 5. If only some of the functions of the gNB 6b are provided at the satellite (e.g. in the system shown in FIG. 2), then the terrestrial gNB 6b may comprise the gNB-CU (central unit) that includes higher layer functions (e.g. PDCP, RRC), and the functions of the gNB 6b at the satellite 5 may comprise, for example, a gNB-DU (distributed unit) that includes lower layer functions (e.g. PHY, MAC, RLC). In other words, the functions of the gNB 6b are split between a non-terrestrial node (the satellite 5) and a terrestrial node. If all of the functions of the gNB 6b are provided at the satellite 5, then the terrestrial gNB 6b may be omitted entirely, as shown in FIG. 3. An exemplary control plane protocol stack for a regenerative payload is described, for example, in TS 38.821.

### User Equipment (UE)

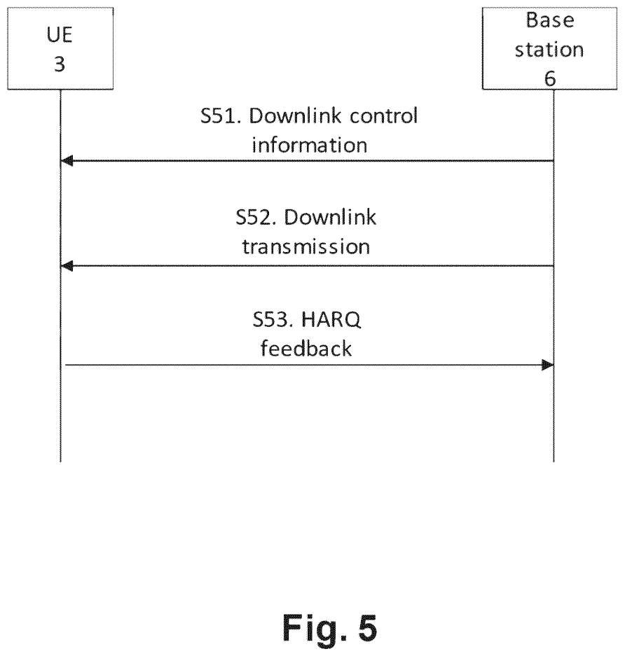

FIG. 2 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 5, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and a HARQ module 45.

The communications control module 43 is responsible for handling (generating/sending/receiving) signalling messages and uplink/downlink data packets between the UE 3 and other nodes, including NTN nodes 5, (R) AN nodes 6, and core network nodes. The signalling may comprise control signalling (such as RRC signalling) related to configuring and assisting cell reselection by the UE 3.

The HARQ module 45 is responsible for controlling the transmission of a HARQ feedback in a HARQ procedure. For example, the UE 3 may receive HARQ control information from the network (e.g. from the gNB 6b, via the NTN gateway 6a and the satellite 5), and may control the transmission of the HARQ feedback based on the received HARQ control information. It will be appreciated that the HARQ module 45 may be configured to control the transmission of HARQ feedback in any of the HARQ procedures described below.

### Base Station/Gateway (Access Network Node)

FIG. 3 is a block diagram illustrating the main components of the gateway/base station 6 shown in FIG. 1 (a base station (gNB) or a similar access network node, the base station need not necessarily be a gNB 6). As shown, the gateway/base station 6 includes a transceiver circuit 71 which is operable to transmit signals to and to receive signals from connected UE(s) 3 via one or more antenna 73 and to transmit signals to and to receive signals from other network nodes (either directly or indirectly) via a network interface 75. Signals may be transmitted to and received from the UE(s) 3 either directly and/or via the NTN node 5, as appropriate. The network interface 75 typically includes an appropriate base station-base station interface (such as X2/Xn) and an appropriate base station-core network interface (such as S1/NG-C/NG-U). A controller 77 controls the operation of the base station 6 in accordance with software stored in a memory 79. The software may be pre-installed in the memory 79 and/or may be downloaded via the telecommunication network 1 or from a removable data storage device (RMD), for example. The software includes, among other things, an operating system 81, a communications control module 83, and a HARQ module 85.

The communications control module 83 is responsible for handling (generating/sending/receiving) signalling between the base station 6 and other nodes, such as the UE 3, NTN nodes 5, and core network nodes. The signalling may comprise control signalling (such as RRC signalling) related to configuring and assisting cell reselection by the UE 3.

The HARQ module 85 is responsible for controlling transmissions related to the HARQ procedure. More generally, the HARQ module 85 may be configured to perform any of the HARQ procedures described below, including the generation or modification of downlink control information, control signalling, or other transmissions related to HARQ procedures.

### HARQ Feedback Procedures

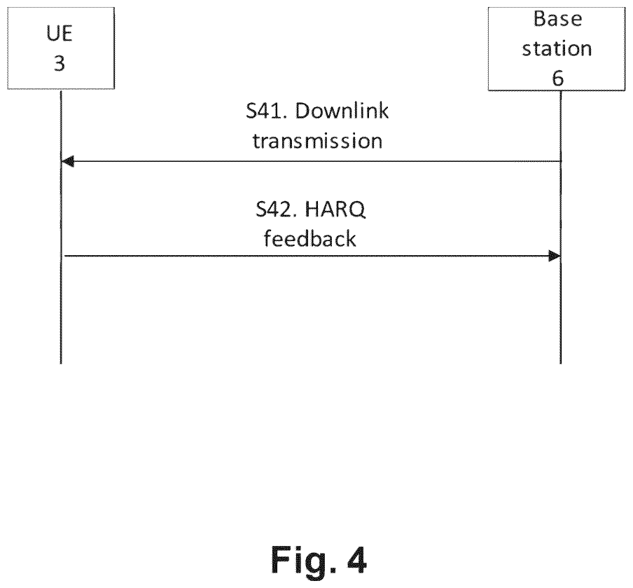

FIG. 4 shows a procedure in which HARQ feedback is transmitted by a UE. In this example, the UE 3 is initially configured to have HARQ feedback enabled. In step S41, a downlink transmission from a base station 6 is received at a UE 3. After receiving the downlink transmission, the UE 3 performs a HARQ procedure and, in step S42, transmits HARQ feedback to the base station 6. Based on the feedback received from the UE 3 in step S42, the base station may re-transmit some or all of the original data transmission.

Some IoT devices support a relatively small number of HARQ processes, and some narrowband IoT UEs may support only a single HARQ process. Considering the limited coverage issue of IoT devices, HARQ feedback for some downlink transmission may be needed. If the HARQ process is always enabled, the data transmission throughput may be reduced (for example, due to the large round-trip-times in an NTN). Moreover, when HARQ feedback is enabled the overall resources available for uplink transmission are recued. For HD-FDD, always-enabled HARQ feedback impacts downlink scheduling and resource allocation in the time domain and impacts the downlink throughput/data-rate, especially for large coupling losses in the uplink that necessitate a large number of repetitions. However, if the HARQ process is always disabled, then system performance and reliability may be degraded. FIG. 5 shows a procedure in which downlink control information is transmitted to the UE 3 in order to enable HARQ feedback.

In this example, the UE 3 may initially be configured to have HARQ feedback disabled. For example, the UE 3 may have disabled HARQ feedback in response to signalling broadcast in a cell of the base station 6 to all of the UEs 3 in the cell. Advantageously, however, downlink control information is used to enable HARQ feedback for a downlink transmission. Alternatively, the UE 3 may initially be configured to have HARQ feedback enabled, and advantageously the downlink control information can be used to disable HARQ feedback for a downlink transmission. In a further alternative, the UE 3 may simply not have any stored information regarding whether HARQ feedback is to be disabled or enabled, and advantageously the downlink control information can be used to enable/disable HARQ feedback for a downlink transmission.

In step S51, downlink control information is transmitted from the base station 6 to the UE 3. The downlink control information includes an indication that HARQ feedback is to be enabled/disabled for a HARQ process. If the HARQ feedback is to be enabled, in response to receiving the downlink control information, the UE 3 enables HARQ feedback for the HARQ process. In step S52 the UE receives a downlink transmission from the base station 6. In step S52, the UE transmits HARQ feedback to the base station 6. Advantageously, the base station 6 can enable HARQ feedback to be transmitted by the UE 3 even when HARQ feedback is initially disabled. Therefore, in this example the UEs 3 can initially be configured to have HARQ feedback disabled (which advantageously reduces the power consumption of the UEs 3), and then enable HARQ feedback in response to signalling received from a base station 6. For example, the base station 6 may determine to transmit downlink control information to enable HARQ feedback when the communication link between the base station 6 and the UE 3 is particularly unreliable.

The downlink control information in step S51 may enable/disable HARQ feedback for a HARQ process for a particular downlink transmission, or for a set of downlink transmissions. In one example, the base station 6 may transmit the downlink control information 51 to enable/disable HARQ feedback for a particular type of transmission from the base station 6 to the UE3. For example, the base station 6 may transmit downlink control information to enable HARQ feedback for an important or critical message to be transmitted to the UE 3 (and therefore feedback for increasing the likelihood that the message can be successfully received at the UE is desirable). For example, the base station 6 may transmit downlink control information to enable HARQ feedback for a downlink transmission that comprises a Physical Downlink Shared Channel (PDSCH) transmission that carries a radio resource control (RRC) message, or medium access control control-element (MAC CE). The MAC CE may be for a Buffer Status Report (BSR) or a Timing Advance Command, etc.

Advantageously, the example described with reference to FIG. 5 enables more flexible scheduling and activation/deactivation of HARQ feedback. In other words, HARQ feedback can be enabled/disabled in certain scenarios, regardless of an initial configuration of the HARQ feedback for the corresponding HARQ process. Moreover, since the indication of whether HARQ feedback is to be enabled/disabled is received in downlink control information (DCI), excessive RRC signalling between the UE 3 and the base station 6 is advantageously avoided.

In one example, the UE 3 may support a plurality of HARQ processes, and at least one of the HARQ processes may be configured with feedback enabled whilst other HARQ processes of the UE 3 are configured with feedback disabled. Advantageously, this enables feedback to be available for certain downlink transmissions, whilst reducing overall power consumption and re-transmissions by disabling feedback for some of the HARQ processes. Advantageously, the HARQ process (or processes) having feedback enabled may be selected by the network to be used for a high priority (e.g. important or critical) downlink transmission. For example, a node of the network may determine a priority or class of a downlink transmission, and select the HARQ process based on the priority or class of the downlink transmission.

For IoT devices, data transmission may be less frequent and the number of HARQ processes may be relatively limited, particularly for narrowband (NB) IoT devices. Advantageously, the downlink control information transmitted to the UE 3 may be used to enable HARQ feedback in a more flexible manner, by indicating a HARQ feedback configuration for the transmission of a particular PDSCH, transport block or data packet.

The downlink control information (DCI) may include a dedicated bit (or bits) for indicating whether HARQ feedback is to be enabled (or disabled) for a HARQ process. For NB-IoT, the DCI could be in the format N1. For eMTC (BL UEs, UEs in CE), the DCI could have DCI format 6-1A/B.

The DCI may include a bit for explicitly indicating whether HARQ feedback is to be enabled/disabled. For example, the DCI may include a bit for explicitly indicating whether HARQ feedback for a corresponding Physical Downlink Shared Channel (PDSCH) is to be enabled (or disabled). For example, a value of ‘1’ may be used to indicate that HARQ feedback is to be enabled, and a value of ‘O’ may be used to indicate that HARQ feedback is to be disabled.

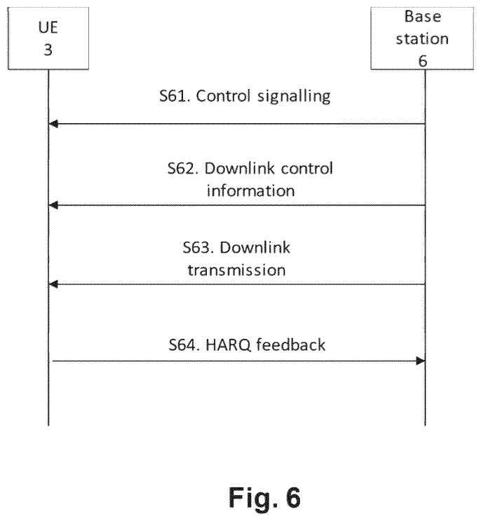

FIG. 6 shows a procedure in which control signalling is transmitted to a UE 3. Advantageously, in this example, the control signalling is used to indicate to the UE 3 whether the indication of whether HARQ feedback is to be enabled/disabled is included in the downlink control information. The UE 3 may initially store information indicating that HARQ feedback is enabled, may initially store information indicating that HARQ feedback is disabled, or may alternatively not initially store HARQ information indicating whether HARQ feedback is enabled or disabled.

In step S61, control signalling is transmitted from the base station 6 to the UE 3.

In this example, the control signalling indicates whether downlink control information includes an indication of whether HARQ feedback is to be enabled/disabled. In this example, the DCI includes the indication of whether HARQ feedback is to be enabled/disabled, and so the control signalling indicates that the DCI includes the indication.

In step S62, the DCI is transmitted from the base station 6 to the UE 3. The UE 3 determines, based on DCI, that the HARQ feedback is to be enabled/disabled.

In step S63, the UE 3 receives a downlink transmission from the base station 6.

In step S64, in a case where the DCI indicates that feedback is to be enabled, the UE transmits HARQ feedback for the downlink transmission in accordance with the indication received in the DCI in step S61. Otherwise, in the case where the DCI indicates that feedback is to be disabled, the UE 3 does not transmit the HARQ feedback to the base station 6. In the case where the DCI indicates that feedback is to be disabled, the UE 3 may transmit NACK to the base station corresponding to the HARQ process with feedback disabled, regardless the decoding results of the corresponding PDSCH.

Advantageously, the UE 3 is able to determine that the downlink control information includes the indication of whether HARQ feedback is to be enabled/disabled based on the control signalling received in step 62.

In an alternative, rather than the UE 3 determining whether the DCI includes an indication of whether HARQ feedback is to be enabled/disabled based on control signalling, the UE 3 could determine that the indication is present in the DCI based on an implicit indication. For example, the UE 3 may determine that the indication is present in the DCI when the UE 3 is in cell provided by a non-terrestrial network. The UE 3 may determine that the indication is present in the DCI based on NTN-specific SIB broadcasts in an NTN cell. The UE 3 may determine that a cell is an NTN cell based on the system information, e.g. NTN-specific SIB is scheduled, and therefore can determine that the DCI includes an indication of whether HARQ feedback is to be enabled/disabled.

The indication provided in the DCI may indicate whether HARQ feedback is to be enabled or disabled for a particular HARQ process configured (or supported) for a UE, may indicate whether HARQ feedback is to be enabled or disabled for a set of HARQ process configured (or supported) for a UE, or may indicate whether HARQ feedback is to be enabled or disabled for all HARQ process configured (or supported) for a UE. The DCI may include a bitmap, where each bit of the bitmap indicates whether HARQ feedback is to be enabled for a respective HARQ process. A bit that indicates the HARQ feedback configuration in the DCI may be arranged after bits that indicate a HARQ process ID. Therefore, the UE can determine whether to consider or ignore this bit (e.g. based on an RRC configuration) after decoding the HARQ process ID.

The presence of a bit for indicating the HARQ feedback configuration (i. e. whether HARQ feedback should be enabled) in the DCI may be dependent on the HARQ process id. The bit that indicates the HARQ feedback configuration in the DCI may appear after the bits that indicate the HARQ process ID for ease of UE decoding and reducing the processing burden on the UE. Alternatively, if the bit is present before the HARQ process ID field, then the bit can be reserved or used for other purposed when the bit is not used for HARQ feedback configuration. For example, this bit could be reutilised for indicating extended repetition numbers. In both cases, the UE can determine whether to ignore or consider the bit based on a RRC configuration after decoding the HARQ process ID. Moreover, the UE (for decoding) assume that the bit is always present in DCI. The DCI size might be indicated to the UE (e.g. by the base station 6).

An existing bit or bit field in the DCI may be used to indicate the HARQ configuration. Advantageously, this reduces the DCI size and increases uplink coverage. Since transmission without HARQ feedback is expected to be performed with a better modulation coding scheme (MCS) value or a larger number of transmissions, the MCS field or repetition number field can itself be used to indicate whether HARQ feedback is to be enabled or not. For example, for a subset of values of the MCS field and/or the repetition field number (which may be values that are fixed or RRC configured), the UE can determine that HARQ feedback is not required, and for other values of the MCS field and/or the repetition field number the UE can determine that HARQ feedback is required. In a further example, due to fewer HARQ feedbacks per UE, a lower number of HARQ feedback resources (and thus lower number of HARQ feedback bits) would be required for NTN for the same cell bandwidth. Hence, how the HARQ feedback field is interpreted can also be dependent on whether the cell is of NTN type or not. For example, based on RRC configuration or cell type, the UE may interpret the HARQ feedback field in different ways. In one case, the UE may use the same mapping as present in legacy LTE NBIoT, but in a second case a first bit of the HARQ feedback field can be used to indicate whether HARQ feedback is present or not and the remaining bits can be used to indicate HARQ feedback resources. When the presence of this field within the DCI is based on the HARQ process ID, the UE may first decode the HARQ process ID field before decoding the HARQ feedback field. The HARQ feedback field may be interpreted by the UE based on the outcome of decoding the HARQ feedback configuration bit. For example, if the HARQ feedback configuration bit indicates that HARQ feedback is not required, then the HARQ feedback field can be used for another purpose (e.g. an indication of extended HARQ process ID, MCS value or repetitions).

The control signalling in step S62 may radio resource control (RRC) signalling. The control signalling can be UE-specific signalling that indicates, to a particular UE, whether the DCI includes an indication of whether HARQ feedback is to be enabled/disabled. In one example, the UE 3 may be configured to use the indication of whether HARQ feedback is to be enabled/disabled in the DCI only if the UE 3 receives the control signalling that indicates that the indication is present in the DCI.

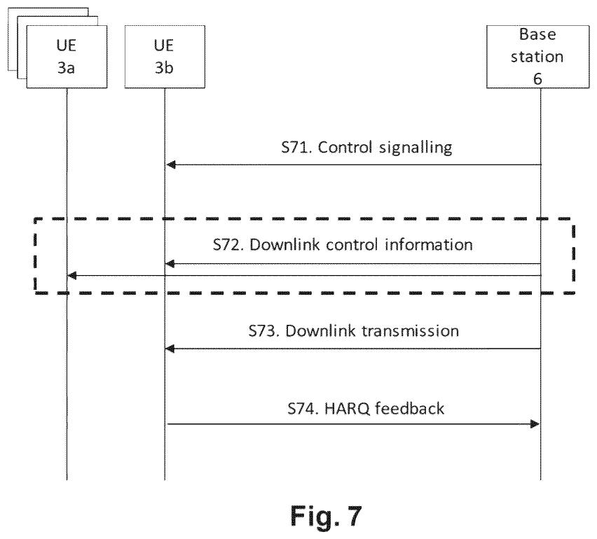

FIG. 7 shows a procedure in which DCI is transmitted to a plurality of UEs (alternatively, the DCI may be transmitted to a specific UE). In this example, HARQ feedback is initially disabled for each for each of the UEs. Alternatively, in this example the HARQ feedback may not be configured for each of the UEs. In other words, the UE may not have received a HARQ configuration, and may not store information regarding whether HARQ feedback is to be enabled or disabled.

In step S71, UE-specific control signalling is transmitted to one of the UEs 3b. The control signalling includes an indication that DCI includes the indication of whether HARQ feedback is to be enabled/disabled.

In step S72, the DCI is transmitted to the plurality of UEs 3a, 3b (e.g. all of the UEs 3 in a cell; alternatively, the DCI may be transmitted to a specific UE). The DCI includes an indication of whether HARQ feedback is to be enabled/disabled. In this example, the DCI indicates that HARQ feedback is to be enabled (e.g. for a particular HARQ process). The UE 3b reads the indication provided in the DCI and determines that HARQ feedback is to be enabled (alternatively, the UE 3b reads the indication provided in the DCI and determines that HARQ feedback is to be enabled/disabled as indicated in the DCI).

In step S73, a downlink transmission is received at the UE 3b from the base station 6.

In step S74, the UE 3b transmits HARQ feedback to the base station corresponding to the downlink transmission, if the HARQ feedback is enabled for the corresponding HARQ process.

Alternatively, the UE 3b does not transmit HARQ feedback to the base station corresponding to the downlink transmission, if the HARQ feedback is disabled for the corresponding HARQ process. Alternatively, the UE 3b may transmit HARQ NACK to the base station corresponding to the downlink transmission regardless the PDSCH decoding result, if the HARQ feedback is disabled for the corresponding HARQ process.

Advantageously, as illustrated in FIG. 7, UE-specific signalling can be used to enable HARQ feedback for a particular UE. For example, the base station 6 may use the signalling to overwrite a HARQ feedback configuration at the UE 3 that has been configured using previous DCI or control information. Alternatively, the UE 3 might not initially have a HARQ feedback configuration.

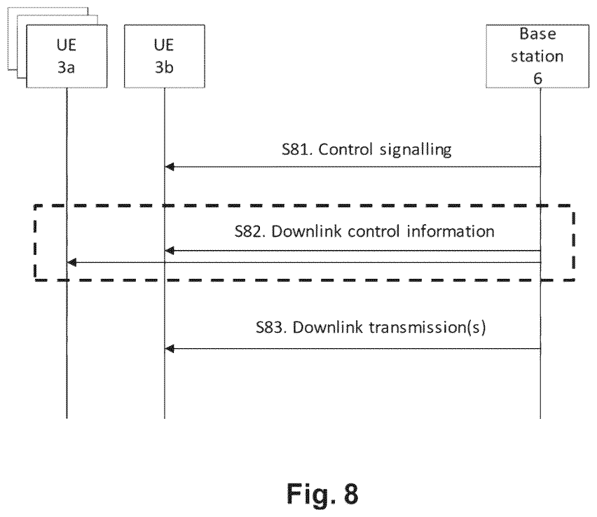

FIG. 8 shows a modification of FIG. 7 in which HARQ feedback is initially enabled for each of the UEs 3a, 3b. Alternatively, in this example the HARQ feedback may not be configured for each of the UEs. In other words, the UE may not have received a HARQ configuration, and may not store information regarding whether HARQ feedback is to be enabled or disabled.

In step S81, UE-specific control signalling is transmitted to one of the UEs 3b. The control signalling includes an indication that DCI includes the indication of whether HARQ feedback is to be enabled.

In step S82, the DCI is transmitted to the plurality of UEs 3a, 3b (e.g. all of the UEs 3 in a cell). The DCI includes an indication of whether HARQ feedback is to be enabled/disabled. In this example, the DCI indicates that HARQ feedback is to be disabled (e.g. for a particular HARQ process). The UE 3b reads the indication provided in the DCI and determines that HARQ feedback is to be disabled.

In step S83, a downlink transmission is received at the UE 3b from the base station. Since the UE 3b has received the indication in the DCI that HARQ feedback is to be disabled, the UE 3b does not transmit HARQ feedback to the base station 6. Advantageously, therefore, HARQ feedback can be disabled (e.g. for a particular downlink transmission), even when HARQ feedback is initially enabled (e.g. by default for all UEs in a cell).

Whilst in the examples illustrated in FIGS. 5 to 8 the indication of whether HARQ feedback is to be enabled/disabled is included in DCI, the indication may be included in any other suitable transmission that is transmitted to the UE by the network. For example, the indication of whether HARQ feedback is to be enabled/disabled may be provided in system information transmitted in a cell (which may be UE-specific or cell-specific system information).

### Enabling/Disabling HARQ Feedback on a Per-Cell Basis

In an NTN, enabling and/or disabling of HARQ feedback for downlink transmissions may be configured per HARQ process via UE-specific signalling. However, the network may alternatively (or additionally) transmit an indication of whether HARQ feedback is to be enabled/disabled to multiple devices (e.g. devices that share similar or the same quality requirements).

In one example, HARQ feedback is enabled/disabled on a per-cell basis. For example, when there are several IoT devices in a cell that receive the same or similar services having the same or similar requirements (e.g. quality requirements), configuring the HARQ feedback on a per-cell basis simplifies the network implementation.

The network may indicate to a group of UEs 3 in a cell that HARQ feedback for all or some HARQ processes is/are to be enabled or disabled. The indication may be provided in system information transmitted (e.g. broadcast) by the base station 6. For example, the indication may be provided in a master information block (MIB(-NB)), system information block 1 (SIB1(-NB)), or an NTN specific SIB (-NB). The indication may be used to indicate that HARQ feedback for some or all of the HARQ processes is to be enabled or disabled. For example, one bit may be used to indicate whether feedback for all HARQ processes is to be enabled or disabled, or a bitmap (or bitmaps) could be used in indicate whether feedback is to be enabled or disabled for a set of respective HARQ processes. For example, the bitmap may comprise a plurality of bits, the first bit indicating whether a first HARQ process is to be configured with feedback enabled, the second bit indicating whether a second HARQ process is to be configured with feedback enabled, and so on. The indication of whether HARQ feedback is to be enabled or disabled may be either an explicit or implicit indication.

In a further example, HARQ feedback is enabled on a per-HARQ process, per-UE basis. For example, the network (e.g. any suitable node in the network) may determine to overwrite a HARQ feedback configuration for a particular UE 3 (or for a particular group of UEs 3). The network may determine to overwrite the HARQ feedback configuration, for example, due to a relatively poor radio link quality, higher service quality requirements, or based on any other suitable type of determination. The HARQ feedback configuration may be transmitted to the UE(s) 3 using, for example, dedicated RRC signalling, MAC CE, or DCI (for example, as described above). When the UE 3 receives the UE-specific signalling, the UE 3 applies the HARQ feedback configuration provided in the signalling and ignores or overwrites the previous cell-specific configuration for the HARQ feedback.

### HARQ Feedback for PUR

For uplink transmission using preconfigured uplink resources (PUR), the UE may receive downlink transmission, e.g. N/MPDSCH, after the UE sends uplink transmission to the network. However, when the UE has received a HARQ feedback configuration when the UE is in an RRC connected state, there is a problem that the UE releases the HARQ feedback configuration upon entering an RRC idle state (e.g. after receiving an RRCConnectionRelease message). Therefore, the UE may be unable to determine a HARQ feedback configuration to use for a procedure involving PUR.

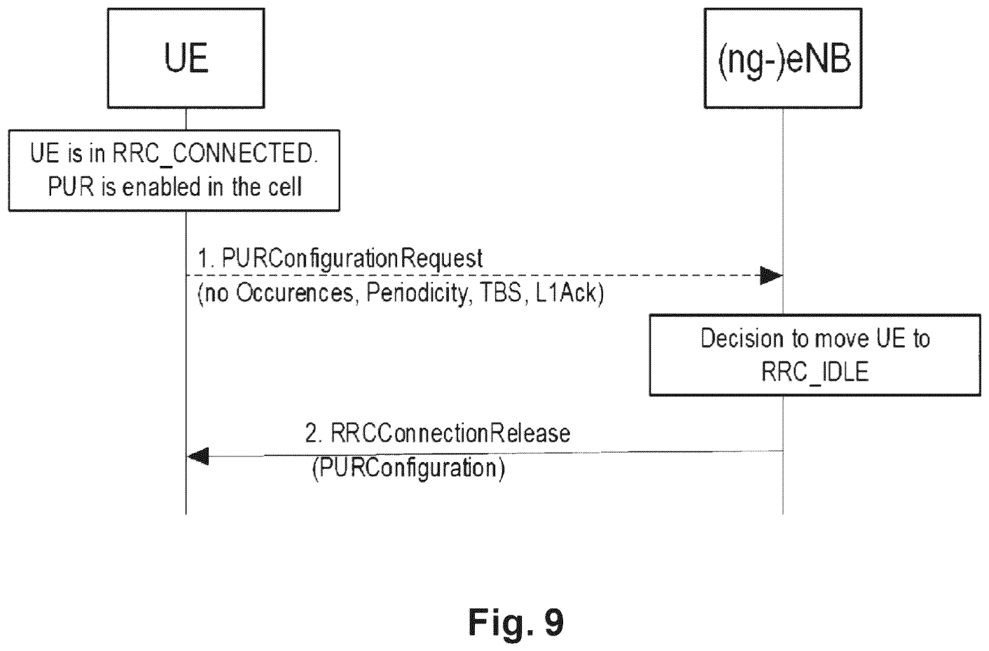

FIG. 9 shows an exemplary preconfigured uplink resources (PUR) configuration request and PUR configuration procedure. As shown in the FIG. 9, the UE is initially RRC_CONNECTED and PUR is enabled in the cell. The procedure is explained in more detail in TS 36.300.

In optional step 1, a PURConfigurationRequest message may be transmitted to an (ng-)eNB (although any other suitable base station may be used) from a UE 3. to the (ng-)eNB may take the request into consideration when moving the UE to RRC_IDLE mode. In step 2, an RRCConnectionRelease is transmitted from the (ng-)eNB to the UE 3. If the (ng-)eNB determines to configure PUR of the UE, PURConfiguration IE is sent in the RRCConnectionRelease.

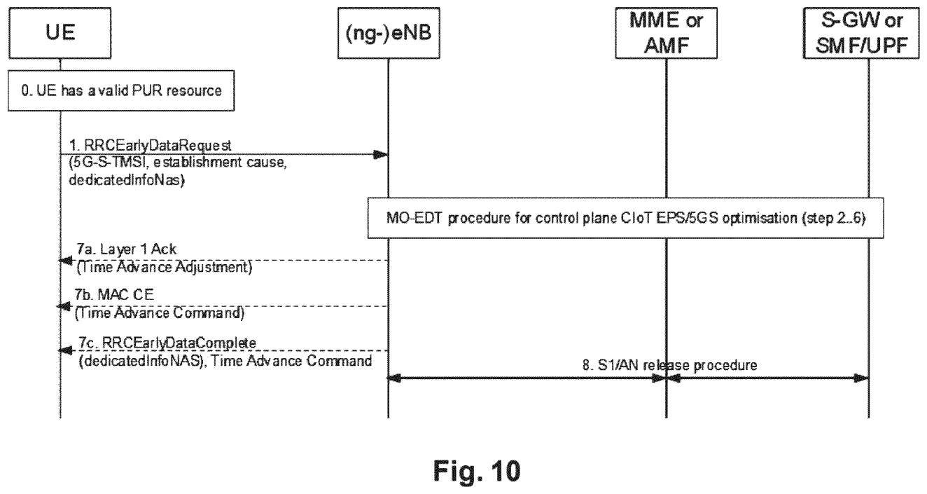

FIG. 10 shows an example of transmission using PUR for Control Plane CIoT EPS/5GS optimisations. The procedure is explained in more detail in TS 36.300.

In step 0, the UE has a valid PUR resource.

In step 1, the UE transmits an RRCEarly DataReequest message to the (ng-)eNB. After the RRCEarly DataReequest message has bene received at the (ng-)eNB, a MO-EDT procedure for control plane CIOT EPS/5GS optimisation is performed between the (ng-)eNB, MME or AMF, and the S-GW or SMF/UPF.

In step 7a a Layer 1 Ack is transmitted from the (ng-)eNB to the eNB.

In step 7b a MAC CE is transmitted from the (ng-)eNB to the eNB.

In step 7c a RRCEarlyDataComplete message is transmitted from the (ng-)eNB to the eNB.

In step 8, an S1/AN release procedure is performed.

Advantageous methods of providing a HARQ feedback configuration to the UE that can be used as part of a PUR procedure will now be described.

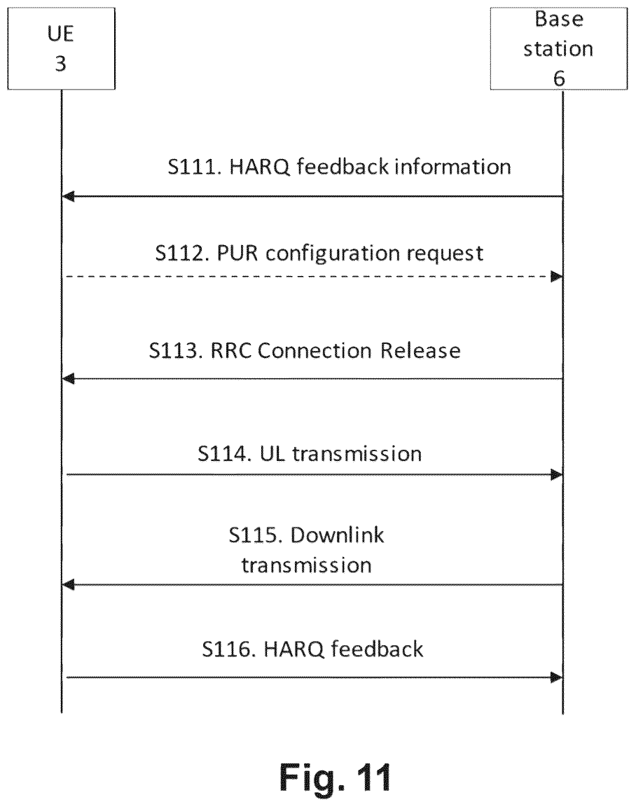

FIG. 11 shows a procedure including the transmission of HARQ feedback after a UE has received an RRC connection release message.

In step S111, the UE 3 receives HARQ feedback configuration information from the base station 6. The HARQ feedback configuration information indicates a HARQ feedback configuration to be used by the UE 3 (e.g. whether HARQ feedback is to be enabled/disabled for a HARQ process).

In optional step S112 the UE transmits a PUR configuration request to the base station 6. After the base station 6 has received the PUR configuration request, the base station 6 transmits an RRC connection release message S113 to the UE 3, and the UE enters an RRC idle mode. Advantageously, however, the UE continues to store the HARQ feedback configuration information received in step S111.

In step S114 the UE 3 transmits an uplink transmission to the base station 6.

In step S115 the UE 3 receives a downlink transmission from the base station 6.

In step S116 the UE 3 transmits HARQ feedback corresponding to the downlink transmission to the UE 3, based on the HARQ feedback configuration information received in step S111.

Advantageously, in this example the UE stores the configuration for the HARQ feedback received/applied when the UE is in the RRC connected state, and reuses the configuration during the UL transmission procedures in PUR. Therefore, the UE is able to determine the HARQ feedback configuration for use in the PUR procedure.

If the UE re-enters the RRC connected state and/or further HARQ configuration information is received, the UE may apply the new HARQ configuration.

Alternatively, the network may indicate a HARQ feedback configuration to the UE during the PUR procedure (e.g. included in PURConfiguration illustrated in FIG. 9). The HARQ feedback configuration may indicate whether HARQ feedback is to be enabled/disabled, or that the HARQ feedback is to be enabled if a corresponding information element (IE) is configured. The HARQ feedback configuration may be indicated, for example, per HARQ process and/or per UE. Alternatively, similar to the method illustrated in FIG. 6, information provided in the PUR configuration may indicate that downlink control information transmitted to the UE (or to be transmitted to the UE) includes information for configurating the HARQ feedback.

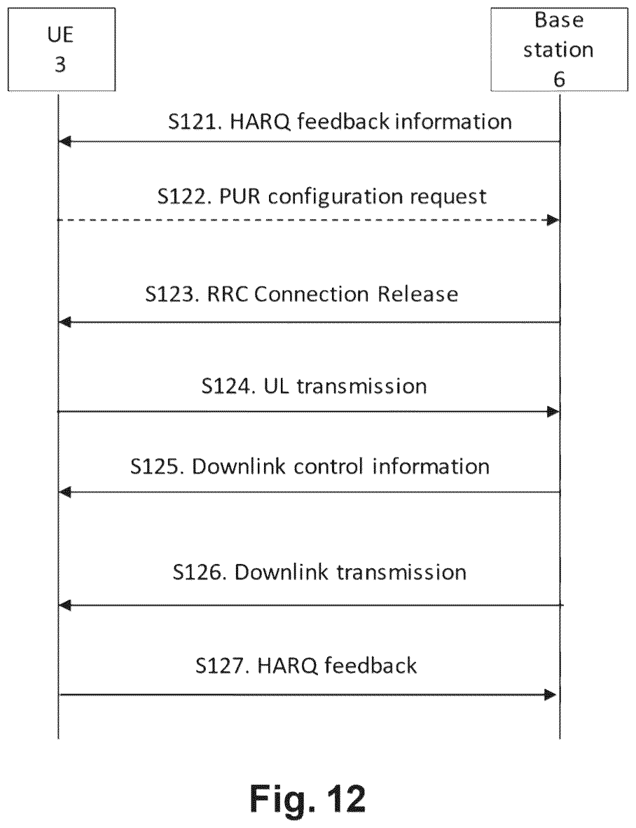

FIG. 12 shows a further procedure including the transmission of HARQ feedback after a UE has received an RRC connection release message. In this example, DCI is used to indicate a HARQ feedback configuration for use as part of a PUR procedure.

Steps S121 to S124 and steps S126 and S127 are the same as steps S111 to S116 described with reference to FIG. 11, and so will not be described again here, except that in this example the UE 3 may release (e.g. overwrite or lose) the HARQ feedback configuration information received in step S121.

In step S125, DCI is transmitted from the base station 6 to the UE 3. The DCI includes HARQ feedback configuration information for configuring a HARQ process of the UE (e.g. an indication of whether HARQ feedback is to be enabled/disabled for a HARQ process). The DCI that schedules the corresponding PDSCH or NPDSCH/MPDSCH may be used to include an indication of a HARQ feedback configuration. The indication may be provided in the DCI as described above with reference 5 to 7 (e.g. using a bit to explicitly indicate whether HARQ feedback is to be enabled or disabled). Alternatively, the HARQ feedback configuration may be indicated implicitly, for example when (N) PUCCH resources are not indicated.

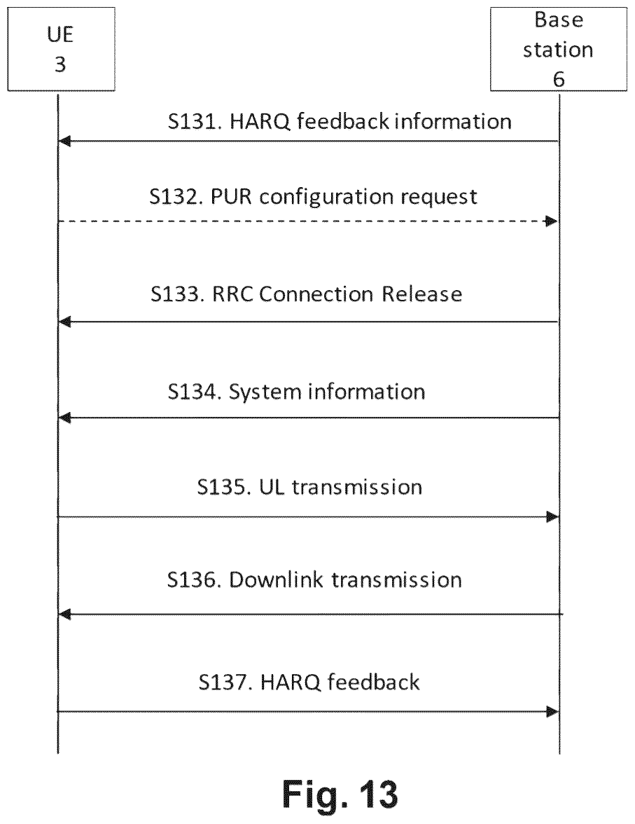

FIG. 13 shows a modification of FIG. 12 in which system information is used to indicate whether HARQ feedback is to be enabled or disabled. Steps 131 to S133, and steps S135 to step S137 are the same as steps S121 to S123, and steps S125 to step S127, respectively, and so will not be described again here. The UE 3 may release (e.g. overwrite or lose) the HARQ feedback configuration information received in step S131.

In step 134 system information is transmitted by the base station 6 and received as the UE 3. The system information includes the indication of whether HARQ feedback is to be enabled or disabled (for example, as previously described above). The system information may be broadcast in a cell of the base station 6, and therefore in this example the indication of whether HARQ feedback is to be enabled or disabled is a cell-specific indication. Advantageously, therefore, the indication of whether HARQ feedback is to be enabled or disabled can be efficiently broadcast to a plurality of UEs 3.

### Modifications and Alternatives

Detailed embodiments have been described above. As those skilled in the art will appreciate, a number of modifications and alternatives can be made to the above embodiments whilst still benefiting from the disclosures embodied therein. By way of illustration only a number of these alternatives and modifications will now be described.

Whilst the above examples have been described with reference to a network comprising a non-terrestrial network element, this need not necessarily be the cased. Benefits of the present disclosure are nevertheless achieved even when implemented in a terrestrial network. For example, the methods of transmitting the HARQ feedback configurations in the present disclosure enable efficient and reliable signalling of HARQ configuration information even when implemented in a terrestrial network.

Whilst the above examples have been described with reference to HARQ feedback for downlink transmissions, it will be appreciated that some of above-described examples could also be applied to feedback for uplink transmissions.

Whilst the above examples have been described mainly with reference to transmissions between a UE 3 and a base station 6, it will be appreciated that the signalling may alternatively be between the UE 3 and any other suitable node in the network.

It will be appreciated that the above-described examples may be applied to (but is not limited to) any suitable NTN comprising any suitable type of non-terrestrial node. Example of satellites (GEO, MEO, LEO, etc.) that could be used to perform a measurement for estimating a position of a UE 3 include:

TABLE 1
types of satellites and UAS platforms

| | | | | Typical beam |
|---|---|---|---|---|
| Platforms | Altitude range | | Orbit | footprint size |
| Low-Earth Orbit | 300-1500 | km | Circular around | 100-1000 km |
| (LEO) satellite | | | the earth | |
| Medium- | 7000-25000 | km | | 100-1000 km |
| Earth Orbit | | | | |
| (MEO) satellite | | | | |
| Geostationary | 35 786 | km | Notional station | 200-3500 km |
| Earth Orbit | | | keeping position | |
| (GEO) satellite | | | fixed in terms of | |
| UAS platform | 8-50 | km | elevation/azimuth | 5-200 km |
| (including HAPS) | (20 km | | with respect to a | |
| | for HAPS) | | given earth point | |
| High Elliptical | 400-50000 | km | Elliptical around | 200-3500 km |
| Orbit (HEO) | | | the earth | |
| satellite | | | | |

Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.7.0 and TS 37.340 V16.7.0 define the following nodes, amongst others:

gNB: node providing NR user plane and control plane protocol terminations towards the UE, and connected via the NG interface to the 5G core network (5GC).

ng-eNB: node providing E-UTRA user plane and control plane protocol terminations towards the UE, and connected via the NG interface to the 5GC. En-gNB: node providing NR user plane and control plane protocol terminations towards the UE, and acting as Secondary Node in E-UTRA-NR Dual Connectivity (EN-DC).

NG-RAN node: either a gNB or an ng-eNB.

It will be appreciated that the above embodiments may be applied to both 5G New Radio and LTE systems (E-UTRAN). A base station (gateway) that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

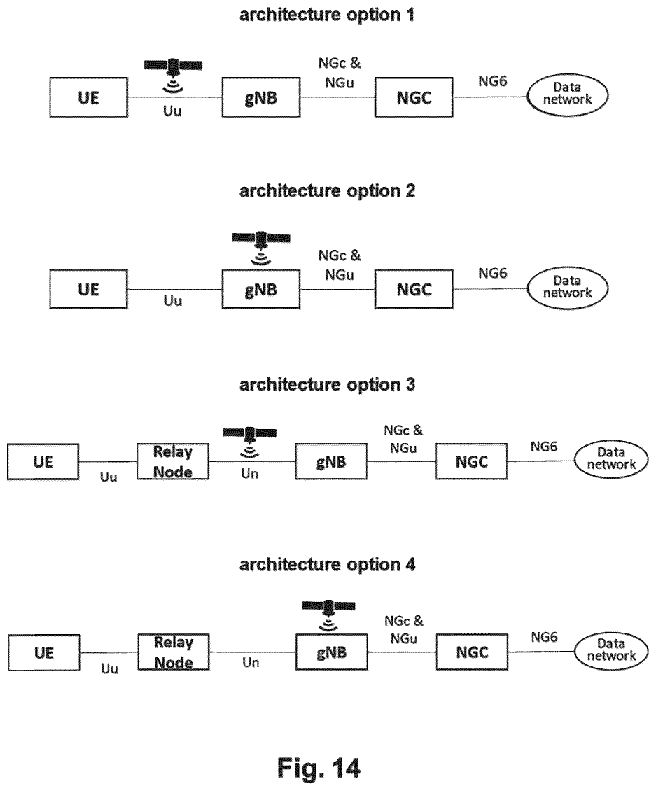

It will be appreciated that there are various architecture options to implement NTN in a 5G system, some of which are illustrated schematically in FIG. 14. The first option shown is an NTN featuring an access network serving UEs and based on a satellite/aerial with bent pipe payload and gNB on the ground (satellite hub or gateway level). The second option is an NTN featuring an access network serving UEs and based on a satellite/aerial with gNB on board. The third option is an NTN featuring an access network serving Relay Nodes and based on a satellite/aerial with bent pipe payload. The fourth option is an NTN featuring an access network serving Relay Nodes and based on a satellite/aerial with gNB. It will be appreciated that other architecture options may also be used, for example, a combination of two or more of the above-described options. Alternatively, the relay node may comprise a satellite/UAS. It will be appreciated that similar architecture options may be used in 4G/LTE systems as well, but with an eNB instead of the gNB, an EPC instead of NGC, and using the appropriate LTE interfaces instead of the NG interfaces shown in FIG. 19.

Each cell has an associated ‘NR Cell Global Identifier’ (NCGI) to identify the cell globally. The NCGI is constructed from the Public Land Mobile Network (PLMN) identity (PLMN ID) the cell belongs to and the NR Cell Identity (NCI) of the cell. The PLMN ID included in the NCGI is the first PLMN ID within the set of PLMN IDs associated to the NR Cell Identity in System Information Block Type 1 (SIB1). The ‘gNB Identifier’ (gNB ID) is used to identify a particular gNB within a PLMN. The gNB ID is contained within the NCI of its cells. The ‘Global gNB ID’ is used to identify a gNB globally and it is constructed from the PLMN identity the gNB belongs to and the gNB ID. The Mobile Country Code (MCC) and Mobile Network Code (MNC) are the same as included in the NCGI.

In the above description, the UE and the access network node (base station) are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware, or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, the NTN node, and the access network node (base station) as a signal over a computer network, or on a recording medium. Further, the functionality performed by part or all of this software may be performed using one or more dedicated hardware circuits. However, the use of software modules is preferred as it facilitates the updating of the UE, the NTN node, and the access network node (base station) in order to update their functionalities.

The above embodiments are also applicable to ‘non-mobile’ or generally stationary user equipment. The above-described mobile device (UE) may comprise an MTC/IoT device, a power saving UE, and/or the like. Various other modifications will be apparent to those skilled in the art and will not be described in further detail here.

For example, the whole or part of the exemplary embodiments disclosed above can be described as, but not limited to, the following supplementary notes.

### (Supplementary Note 1)

A method for a user equipment (UE), the method comprising:
receiving first information that includes an indication for a Hybrid Automatic Repeat Request (HARQ) process; and
determining whether a feedback for the HARQ process is enabled or not based on the first information.

### (Supplementary Note 2)

The method according to supplementary note 1, wherein
the first information includes feedback configuration information for the HARQ process supported by the UE, wherein the feedback configuration information indicates that HARQ feedback is disabled for the HARQ process, and
the determining includes enabling feedback for the HARQ process in a case where a downlink transmission is a specific type of downlink transmission.

### (Supplementary Note 3)

The method according to supplementary note 1, wherein the first information includes downlink control information for the HARQ process; and
the determining includes determining whether the downlink control information includes an indication of whether the feedback for the HARQ process is to be enabled or disabled for a downlink transmission.

### (Supplementary Note 4)

The method according to supplementary note 3, further comprising:
determining, in a case where the downlink transmission is for transmission in a cell of a non-terrestrial network portion, that the downlink control information includes the indication.

### (Supplementary Note 5)

The method according to supplementary note 3 or 4, wherein the determination of whether the downlink control information includes the indication is based on system information broadcast in a cell.

### (Supplementary Note 6)

The method according to any one of supplementary notes 3 to 5, further comprising:
receiving control signalling that includes an indication of whether the downlink control information is adapted to include the indication; and
determining whether the downlink control information includes the indication based on the control signalling.

### (Supplementary Note 7)

The method according to supplementary note 1, further comprising:
receiving, from a network node, a cell-specific feedback indication that indicates whether feedback for the HARQ process is to be enabled or disabled for downlink transmissions in a cell; and wherein
the receiving the first information includes receiving from the network, a UE-specific feedback indication that indicates whether the feedback for HARQ process is to be enabled for a downlink transmission, and
the determining includes determining whether the feedback for the HARQ process is to be enabled based on the UE-specific feedback indication irrespective of the cell-specific feedback indication.

### (Supplementary Note 8)

The method according to supplementary note 1, wherein
the receiving includes receiving, from a network node, configuration information for the feedback for the HARQ process; and
using the configuration information to configure the feedback for the HARQ process for a procedure in which the UE performs data transmission to the network node in a radio resource control (RRC) idle state.

### (Supplementary Note 9)

The method according to supplementary note 8, wherein the data transmission to the network node uses preconfigured uplink resources (PUR).

### (Supplementary Note 10)

The method according to supplementary note 8 or 9, wherein the configuration information is received from the network node in a case where the UE is in an RRC connected state.

### (Supplementary Note 11)

The method according to supplementary note 8 or 9, wherein the configuration information is received from the network node in a case where the UE is in an RRC idle state.

### (Supplementary Note 12)

The method according to supplementary note 8, further comprising:
receiving the configuration information from the network node in a preconfigured uplink resource (PUR) configuration message; or
receiving a PUR configuration message that indicates that downlink control information transmitted by the network node includes the configuration information.

### (Supplementary Note 13)

A method for a network node, the method comprising:
transmitting, to a user equipment (UE), first information that includes an indication for at least one Hybrid Automatic Repeat Request (HARQ) process, wherein
the first information causes the UE to determine whether a feedback for the at least one HARQ process is enabled or not based on the first information.

### (Supplementary Note 14)

The method according to supplementary note 13, wherein
the first information includes control information for the UE, wherein the control information indicates that the feedback for the at least one HARQ process is disabled, and the method further comprises:
transmitting downlink transmission to the UE; and
receiving the feedback for the at least one HARQ process in a case where the downlink transmission is a specific type of downlink transmission.

### (Supplementary Note 15)

The method according to supplementary note 14, further comprising:
in a case where the downlink transmission is the specific type of downlink transmission, transmitting, to the UE, an indication that the feedback for the at least one HARQ process is to be enabled.

### (Supplementary Note 16)

The method according to supplementary note 15, wherein the specific type of downlink transmission is a Physical Downlink Shared Channel (PDSCH) transmission that carries a radio resource control (RRC) message, or a medium access control control element (MAC CE).

### (Supplementary Note 17)

The method according to supplementary note 13, wherein the first information includes downlink control information for the UE, wherein the downlink control information includes an indication of whether the feedback for the at least one HARQ process is to be enabled or disabled for a downlink transmission.

### (Supplementary Note 18)

The method according to supplementary note 17, wherein the downlink transmission is scheduled by the downlink control information.

### (Supplementary Note 19)

The method according to supplementary note 17, wherein the indication is included in a bit of the downlink control information.

### (Supplementary Note 20)

The method according to any one of supplementary notes 17 to 19, further comprising:
determining to include, in the downlink control information, a bit for indicating whether the feedback for the at least one HARQ process is to be enabled, when the downlink control information is transmitted in a cell provided using a non-terrestrial network portion.

### (Supplementary Note 21)

The method according to any one of supplementary notes 17 to 20, wherein the downlink control information indicates whether feedback for all HARQ processes of the UE is to be enabled for at least one downlink transmission.

### (Supplementary Note 22)

The method according to any one of supplementary notes 17 to 21, wherein the downlink control information indicates whether feedback for at least one specific HARQ process of the UE is to be enabled for a downlink transmission.

### (Supplementary Note 23)

The method according to any one of supplementary notes 17 to 22, further comprising:
transmitting control signalling for indicating whether the downlink control information includes the indication.

### (Supplementary Note 24)

The method according to supplementary note 23, wherein the control signalling includes radio resource control (RRC) signalling.

### (Supplementary Note 25)

The method according to supplementary note 23 or 24, wherein the control signalling is UE-specific control signalling.

### (Supplementary Note 26)

The method according to any one of supplementary notes 23 to 25, wherein: the control signalling includes a plurality of bits for indicating whether the downlink control information includes an indication of whether the feedback for the at least one HARQ process is to be enabled, each bit respectively indicating whether the downlink control information includes an indication of whether the feedback for one of the at least one HARQ process is to be enabled.

### (Supplementary Note 27)

The method according to any one of supplementary notes 17 to 26, further comprising:
transmitting system information for the UE that indicates whether the downlink control information includes the indication.

### (Supplementary Note 28)

The method according to any one of supplementary notes 17 to 27, wherein the downlink control information further comprises an indication of configuration information for the at least one HARQ process.

### (Supplementary Note 29)

The method according to any one of supplementary notes 17 to 28, wherein the downlink control information indicates, using information related to a modulation coding scheme (MCS) included in the downlink control information, whether the feedback for the at least one HARQ process is to be enabled for the transmission of a particular transport block, data packet or control element.

### (Supplementary Note 30)

The method according to supplementary note 13, wherein the first information includes a cell-specific or UE-specific feedback indication that indicates whether the feedback for the at least one HARQ process is to be enabled for a downlink transmission.

### (Supplementary Note 31)

The method according to supplementary note 30, wherein the feedback indication is included in system information (SI) that is transmitted in a cell.

### (Supplementary Note 32)

The method according to supplementary note 30 or 31, wherein the feedback indication includes information indicating whether HARQ feedback is to be enabled or disabled for all or some HARQ processes in the cell of the non-terrestrial network portion.

### (Supplementary Note 33)

The method according to any one of supplementary notes 30 to 32, wherein the feedback indication includes a bitmap having a plurality of bits, each bit of the bitmap indicating whether HARQ feedback is to be enabled for a respective HARQ processes in the cell of the non-terrestrial network portion.

### (Supplementary Note 34)

A method performed by a network node in a network comprising a non-terrestrial network portion, the method comprising:
selecting a Hybrid Automatic Repeat Request (HARQ) process that is configured with feedback enabled, of a plurality of HARQ processes supported by a user equipment (UE), for providing feedback for the HARQ process relating to a downlink transmission to be transmitted to the UE using the non-terrestrial network portion.

### (Supplementary Note 35)

A user equipment comprising:
means for receiving first information that includes an indication for a Hybrid Automatic Repeat Request (HARQ) process; and
means for determining whether a feedback for the HARQ process is enabled or not based on the first information.

### (Supplementary Note 36)

A network node comprising:
means for transmitting, to a user equipment (UE), first information that includes an indication for at least one Hybrid Automatic Repeat Request (HARQ) process, wherein
the first information causes the UE to determine whether a feedback for the at least one HARQ process is enabled or not based on the first information.

### (Supplementary Note 37)

A network node in a network comprising a non-terrestrial network portion, the network node comprising:
means for selecting a Hybrid Automatic Repeat Request (HARQ) process that is configured with feedback enabled, of a plurality of HARQ processes supported by a user equipment (UE), for providing feedback for the HARQ process relating to a downlink transmission to be transmitted to the UE using the non-terrestrial network portion.

This application is based upon and claims the benefit of priority from Great Britain Patent Application No. 2206252.5, filed on Apr. 28, 2022, the disclosure of which is incorporated herein in its entirety by reference.

### REFERENCE SIGNS LIST

1 TELECOMMUNICATION SYSTEM
3 MOBILE DEVICE
5 NON-TERRESTRIAL NETWORK NODE
6 BASE STATION
7 DATA NETWORK
31 TRANSCEIVER CIRCUIT
33 ANTENNA
35 USER INTERFACE
37 CONTROLLER
39 MEMORY
41 OPERATING SYSTEM
43 COMMUNICATIONS CONTROL MODULE
45 HARQ MODULE
71 TRANSCEIVER CIRCUIT
73 ANTENNA
75 NETWORK INTERFACE
77 CONTROLLER
79 MEMORY
81 OPERATING SYSTEM
83 COMMUNICATIONS CONTROL MODULE
85 HARQ MODULE

What is claimed is:

1. A method for a user equipment (UE), the method comprising:
receiving a Radio Resource Control (RRC) message including information indicating whether downlink control information includes an indication of whether a Hybrid Automatic Repeat Request (HARQ) feedback for a HARQ process is enabled or not;
receiving, via the downlink control information, first information including the indication, in a case where the information included in the RRC message indicates that the downlink control information includes the indication; and
determining whether the HARQ feedback for the HARQ process is enabled or not based on the first information and the information included in the RRC message.

2. The method according to claim 1, wherein the RRC message includes feedback configuration information indicating whether the HARQ feedback for the HARQ process is enabled or not, and
the determining is performed regardless of the feedback configuration information.

3. The method according to claim 2, wherein the determining is performed by overriding the feedback configuration information with the indication.

4. The method according to claim 2, wherein the RRC message includes a bitmap, respective bits of the bitmap indicating feedback configuration per HARQ process.

5. The method according to claim 1, wherein the first information includes information per Transport block (TB) and/or data packet for the HARQ process; and
the determining is performed by determining whether the HARQ feedback for the HARQ process is enabled or not per TB and/or data packet based on the information.

6. The method according to claim 5, wherein the RRC message includes the information per TB and/or data packet, and wherein
the determining is performed per TB and/or data packet in a case where the first information includes the indication of whether the HARQ feedback for the HARQ process is enabled or not per TB and/or data packet.

7. The method according to claim 5, wherein in a case where a downlink transmission for the HARQ process is for transmission in a cell of a non-terrestrial network, the first information includes the indication of whether the HARQ feedback for the HARQ process is enabled or not per TB and/or data packet, and wherein
the determining is performed per TB and/or data packet in a case where the first information includes the indication of whether the HARQ feedback for the HARQ process is enabled or not per TB and/or data packet.

8. The method according to claim 7, further comprising:
determining the cell is a cell of the non-terrestrial network based on system information broadcast in the cell.

9. The method according to claim 6, wherein the RRC message indicates whether the indication of whether the HARQ feedback for the HARQ process is enabled or not per TB and/or data packet is applied to per UE or per HARQ process.

10.-12. (canceled)

13. The method according to claim 2, further comprising:
using the feedback configuration information to configure the HARQ feedback for the HARQ process for a procedure in which the UE performs data transmission to a network node in a RRC idle state.

14. The method according to claim 13, wherein the data transmission to the network node uses a preconfigured uplink resource (PUR).

15. The method according to claim 14, wherein the feedback configuration information is received from the network node in a case where the UE is in an RRC connected state.

16. The method according to claim 14, wherein the feedback configuration information is received from the network node in a case where the UE is in the RRC idle state.

17. The method according to claim 14, further comprising:
receiving the feedback configuration information from the network node in a preconfigured uplink resource (PUR) configuration message; or
receiving a PUR configuration message that indicates that downlink control information transmitted by the network node includes the feedback configuration information.

18.-20. (canceled)

21. A method for a network node, the method comprising:
transmitting, to a user equipment (UE), a Radio Resource Control (RRC) message including information indicating whether downlink control information includes an indication of whether a Hybrid Automatic Repeat Request (HARQ) feedback for a HARQ process is enabled or not; and
transmitting, to the UE via the downlink control information, first information including the indication, in a case where the information included in the RRC message indicates that the downlink control information includes the indication,
wherein the first information causes the UE to determine whether the HARQ feedback for the at least one HARQ process is enabled or not based on the first information and the information included in the RRC message.

22.-40. (canceled)

41. A user equipment (UE) comprising:
at least one memory storing instructions; and
at least one processor executing the instructions to:
receive a Radio Resource Control (RRC) message including information indicating whether downlink control information includes an indication of whether a Hybrid Automatic Repeat Request (HARQ) feedback for a HARQ process is enabled or not;
receive, via the downlink control information, first information including the indication, in a case where the information included in the RRC message indicates that the downlink control information includes the indication; and
determine whether the HARQ feedback for the HARQ process is enabled or not based on the first information and the information included in the RRC message.

42. A network node comprising:
at least one memory storing instructions; and
at least one processor executing the instructions to:
transmit, to a user equipment (UE), a Radio Resource Control (RRC) message including information indicating whether downlink control information includes an indication of whether a Hybrid Automatic Repeat Request (HARQ) feedback for a HARQ process is enabled or not; and
transmit, to the UE via the downlink control information, first information including the indication, in a case where the information included in the RRC message indicates that the downlink control information includes the indication,
wherein the first information causes the UE to determine whether the HARQ feedback for the at least one HARQ process is enabled or not based on the first information and the information included in the RRC message.
